(19) United States
(12) Patent Application Publication
(10) Pub. No.: US 2022/0156725 A1
(43) Pub. Date: May 19, 2022

(54) CROSS-CHAIN SETTLEMENT MECHANISM

(71) Applicant: International Business Machines Corporation, Armonk, NY (US)

(72) Inventors: Futoshi Iwama, Tokyo (JP); Sachiko Yoshihama, Kawasaki-shi (JP); HIROYUKI Kitayama, Yokohama (JP)

(21) Appl. No.: 16/951,570

(22) Filed: Nov. 18, 2020

(51) Int. Cl. G06Q 20/36; H04L 9/06; G06Q 20/10

(52) U.S. Cl. CPC G06Q 20/3676; H04L 9/0618; H04L 2209/38; G06Q 20/102; G06Q 20/3672

(57) ABSTRACT

A processor may assign a bridging blockchain client. The bridging blockchain client may link a first system to a second system. The first and second systems may be on one or more blockchains. The processor may identify that an exchange has been initiated. The processor may generate one or more assets in response to the exchange. The processor may process the exchange. The processing of the exchange may include the bridging blockchain client accepting a probability of failure of the exchange.

### BACKGROUND

The present disclosure relates generally to the field of cross-chain settlements, and more specifically to protecting an asset involved in a cross-chain exchange.

Several blockchain systems have recently been connecting to other ledger embedded systems (e.g. other blockchain systems) to exchange assets across ledger-systems. In such cross-chain asset exchanges, each ledger system may user a different exchange protocol and it may further be difficult to roll back transactions when the trade-process stops before completion of the exchange.

### SUMMARY

Embodiments of the present disclosure include a method, system, and computer program for cross-chain settlements. A processor may assign a bridging blockchain client. The bridging blockchain client may link a first system to a second system. The first and second systems may be on one or more blockchains. The processor may identify that an exchange has been initiated. The processor may generate one or more assets in response to the exchange. The processor may process the exchange. The processing of the exchange may include the bridging blockchain client accepting a probability of failure of the exchange.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A illustrates an example blockchain architecture, in accordance with embodiments of the present disclosure.

FIG. 1B illustrates a blockchain transactional flow, in accordance with embodiments of the present disclosure.

FIG. 2 illustrates an example system for cross-chain settlements, in accordance with embodiments of the present disclosure.

FIG. 3 illustrates a flowchart of an example method for cross-chain settlements, in accordance with embodiments of the present disclosure.

FIG. 4A illustrates a cloud computing environment, in accordance with embodiments of the present disclosure.

FIG. 4B illustrates abstraction model layers, in accordance with embodiments of the present disclosure.

FIG. 5 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of cross-chain settlements, and more specifically to protecting an asset involved in a cross-chain exchange. Currently, several blockchain systems have recently been connecting to other ledger embedded systems (e.g. other blockchain and/or legacy transaction systems) to trade (e.g., sometimes referred to as exchange and/or transaction) assets across ledger-systems. In such cross-chain asset trading, it is difficult to roll back transactions when the trade-process stops halfway (e.g., stops before completion), consequentially how to take risk of a transaction interruption becomes a problem (e.g., which ledger embedded system takes the risk of the transaction being interrupted as it can lead to a loss of a processing fee, a loss of the asset transfer, etc.).

Further, another problem may occur due to what kind of trading protocol is appropriate for the transaction (e.g., asset trade/exchange) as the protocol depends on the functions of each of the two ledger systems that conduct the transaction and/or the type of assets to be traded (e.g., a different protocol for a coin-based system trading a currency versus a protocol for a physical-asset based system trading a car title).

Presently though, most proposed cross-chain transactions can handle only coins as trading-assets. Also, when handling assets other than coins, it is almost always assumed that the two systems that conduct transactions both realize smart contracts (e.g., hash-(time)-locked atomic swap).

Accordingly, disclosed herein is an invoice/coin cross-chain settlement mechanism. That is, it is assumed that a first (e.g., one) system manages invoices and a second (e.g., another) system manages coins and that the proposed protocol (e.g. method, mechanism, etc.) transfers coins according to the invoice in one system and issues a receipt for the coin transfer in another system.

Further disclosed herein, the proposed protocol assumes that the first (e.g., invoice-management) system is based on blockchain with smart contract functions and assumes that the second (e.g., coin-management) system has the function to execute coin transfer and the function to get the result of the transfer (or transaction's reference number). Thus, disclosed herein is a solution that provides a cross-chain transaction protocol in the form that participants (e.g., the first and/or second systems) other than intermediaries (e.g., bridging blockchain client [to be discussed more fully below]) do not lose any asset(s) (e.g., coins, invoices, etc.) even when the processing is interrupted under the above-mentioned assumptions. In an embodiment, the solution presented herein provides a preliminary deposit function (e.g., a bridging blockchain client, notary blockchain client, etc.) for reducing the risk of uncollected service charges (e.g., do to asset exchange interruptions).

As will be discussed more fully below and throughout this specification, but as a general overview, the proposed solution(s) may include a Notary Blockchain client (NC) (or as referred to herein as a bridging blockchain client) bridges an invoice-management-system (ISys) (or as referred to herein as either a first and/or second system) and a coin-management-system (Csys) (or as referred to herein as either a first and/or second system), and the NC may have an account ‘N’ on the ISys. In some embodiments, the ISys may (generate and/or) manage three kind of assets: an invoice, a receipt, and a deposit. In some embodiments, the NC may need to have functions to transfer/exchange an X amount of coins to an entity A (e.g., a user, an institution, etc.) for the deposit asset [from:A, to:N, X coins]′ whenever a refund is required (e.g., due to time lapse, an interruption, etc.). In some embodiments, the NC executes creation (e.g., generation) processes for the three assets (e.g. the invoice, the receipt, and the deposit) and the accompanying coins transfer in such a way that the NC takes the risk associated with the interruption of the movement process.

As an overview example of the solution(s) provided herein, an invoice asset [from:Alice, to:Bob, amount:2000, rate:0.001, N, iid]′ may be generated, where Alice is a transferring entity (e.g., transferring one asset) and where Bob is a receiving entity (e.g., receiving the one asset), the amount is the amount of coins (e.g., the [one] asset to be transferred/exchanged), the rate is the processing rate/fee (of the NC), N is the account the NC has on a platform that implements smart contracts and which may be exclusive a platform housing the coins, and where iid is the invoice identification (number); non-conventionally, the invoice asset indicates that Alice has submitted a 2000 coin transfer and the coin transfer first goes from Alice to N of the NC. Further, the NC creates/generates a deposit asset ‘[from:Alice, to:N, amount:2000, did]’, where the did is the deposit identification (number); in some embodiments, the deposit asset is generated in the manner of a timed execution lock with cancellation for the associated 2000 coin transfer from Alice to N (e.g., which allows for failure detected transactions to not continue). Subsequently, the NC creates/generates a receipt asset [from:Alice, to:Bob, amount:2000, iid, did, rid], where the rid is the receipt identification (number); in some embodiments, the receipt asset is generated in the manner of the timed rollback lock with permission for associated 2000*0.999 (e.g., the 1 minus the rate) coin transfer from N to Bob (e.g., which allows for refunds). In some embodiments, simultaneous to the deposit asset being used to transfer the coins to N of NC, a new deposit asset “[from:Bob, to:N, amount:2000*0.999, did2]” may be created/generated and it may be used for coin transfer from N to Bob.

Before turning to the FIGS., it will be readily understood that the instant components, as generally described and illustrated in the figures herein, may be arranged and designed in a wide variety of different configurations. Accordingly, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the FIGS., any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

In addition, while the term “message” may have been used in the description of embodiments, the application may be applied to many types of networks and data. Furthermore, while certain types of connections, messages, and signaling may be depicted in exemplary embodiments, the application is not limited to a certain type of connection, message, and signaling.

Detailed herein are a method, system, and computer program product that utilize specialized blockchain components (e.g., a bridging blockchain client to be discussed in more detail below) to protect an asset involved in a cross-chain exchange.

In some embodiment, the method, system, and/or computer program product utilize a decentralized database (such as a blockchain) that is a distributed storage system, which includes multiple nodes that communicate with each other. The decentralized database may include an append-only immutable data structure resembling a distributed ledger capable of maintaining records between mutually untrusted parties. The untrusted parties are referred to herein as peers or peer nodes. Each peer maintains a copy of the database records and no single peer can modify the database records without a consensus being reached among the distributed peers. For example, the peers may execute a consensus protocol to validate blockchain storage transactions, group the storage transactions into blocks, and build a hash chain over the blocks. This process forms the ledger by ordering the storage transactions, as is necessary, for consistency.

In various embodiments, a permissioned and/or a permission-less blockchain can be used. In a public, or permission-less, blockchain, anyone can participate without a specific identity (e.g., retaining anonymity). Public blockchains can involve native cryptocurrency and use consensus based on various protocols such as Proof of Work or Proof of Stake. Whereas, a permissioned blockchain database provides secure interactions among a group of entities that share a common goal but which do not fully trust one another, such as businesses that exchange funds, goods, (private) information, and the like.

Further, in some embodiment, the method, system, and/or computer program product can utilize a blockchain that operates arbitrary, programmable logic, tailored to a decentralized storage scheme and referred to as “smart contracts” or “chaincodes.” In some cases, specialized chaincodes may exist for management functions and parameters which are referred to as system chaincode (such as managing access to a different blockchain, a bridging blockchain client, etc.). In some embodiments, the method, system, and/or computer program product can further utilize smart contracts that are trusted distributed applications that leverage tamper-proof properties of the blockchain database and an underlying agreement between nodes, which is referred to as an endorsement or endorsement policy.

An endorsement policy allows chaincode to specify endorsers for a transaction in the form of a set of peer nodes that are necessary for endorsement. When a client sends the transaction to the peers (e.g., endorsers) specified in the endorsement policy, the transaction is executed to validate the transaction. After validation, the transactions enter an ordering phase in which a consensus protocol is used to produce an ordered sequence of endorsed transactions grouped into blocks.

In some embodiment, the method, system, and/or computer program product can utilize nodes that are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node that submits a transaction-invocation to an endorser (e.g., peer), and broadcasts transaction-proposals to an ordering service (e.g., ordering node).

Another type of node is a peer node which can receive client submitted transactions, commit the transactions, and maintain a state and a copy of the ledger of blockchain transactions. Peers can also have the role of an endorser, although it is not a requirement. An ordering-service-node or orderer is a node running the communication service for all nodes, and which implements a delivery guarantee, such as a broadcast to each of the peer nodes in the system when committing/confirming transactions and modifying a world state of the blockchain, which is another name for the initial blockchain transaction which normally includes control and setup information.

In some embodiment, the method, system, and/or computer program product can utilize a ledger that is a sequenced, tamper-resistant record of all state transitions of a blockchain. State transitions may result from chaincode invocations (e.g., transactions, transfers, exchanges, etc.) submitted by participating parties (e.g., client nodes, ordering nodes, endorser nodes, peer nodes, etc.). Each participating party (such as a peer node) can maintain a copy of the ledger. A transaction may result in a set of asset key-value pairs being committed to the ledger as one or more operands, such as creates, updates, deletes, and the like. The ledger includes a blockchain (also referred to as a chain) which is used to store an immutable, sequenced record in blocks. The ledger also includes a state database that maintains a current state of the blockchain.

In some embodiment, the method, system, and/or computer program product described herein can utilize a chain that is a transaction log that is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (e.g., local, attached storage, cloud, etc.), efficiently supporting the append-only nature of the blockchain workload.

The current state of the immutable ledger represents the latest values for all keys that are included in the chain transaction log. Since the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated) upon peer node startup, and before transactions are accepted.

Some benefits of the instant solutions described and depicted herein include a method, system, and computer program product for implementing new, novel blockchain components that help protect an asset(s) involved in a cross-chain exchange. The exemplary embodiments solve the issues of asset claims involving multiple blockchains (e.g., cross-chain exchanges) and the occurrences of interruptions involving said blockchains.

It is noted that blockchain is different from a traditional database in that blockchain is not a central storage, but rather a decentralized, immutable, and secure storage, where nodes may share in changes to records in the storage. Some properties that are inherent in blockchain and which help implement the blockchain include, but are not limited to, an immutable ledger, smart contracts, security, privacy, decentralization, consensus, endorsement, accessibility, and the like, which are further described herein. According to various aspects, the system described herein is implemented due to immutable accountability, security, privacy, permitted decentralization, availability of smart contracts, endorsements and accessibility that are inherent and unique to blockchain.

In particular, the example embodiments provide numerous benefits over a traditional database. For example, through the blockchain, the embodiments provide for immutable accountability, security, privacy, permitted decentralization, availability of smart contracts, endorsements and accessibility that are inherent and unique to the blockchain.

Meanwhile, a traditional database could not be used to implement the example embodiments because it does not bring all parties on the network, it does not create trusted collaboration and does not provide for an efficient commitment of transactions involving verifiable credentials. The traditional database does not provide for tamper proof storage and does not provide for preservation of asset related costs (e.g., computing costs, such as processing power, fees, etc.) if an asset exchange is interrupted. Thus, the proposed embodiments described herein utilizing blockchain networks cannot be implemented by the traditional database.

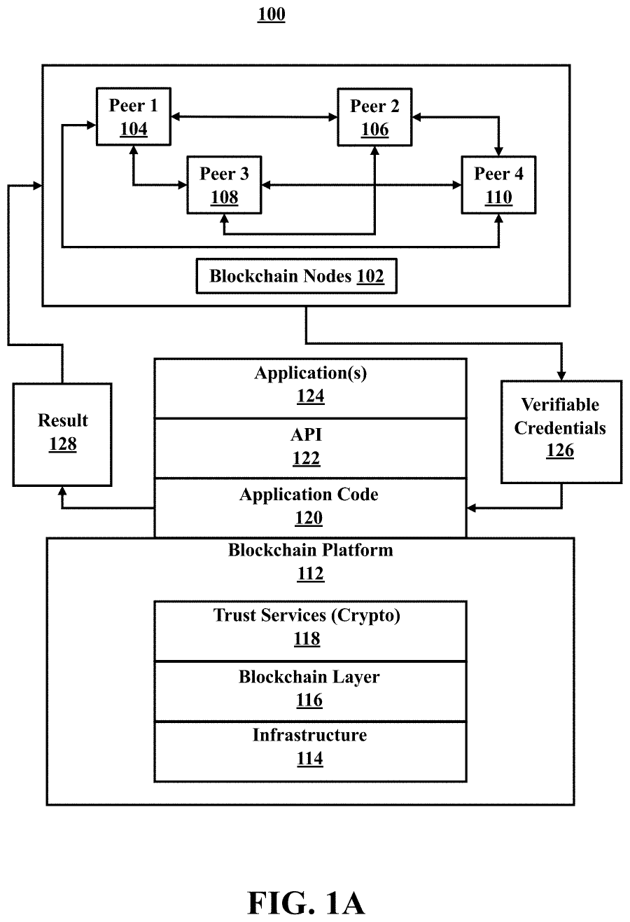

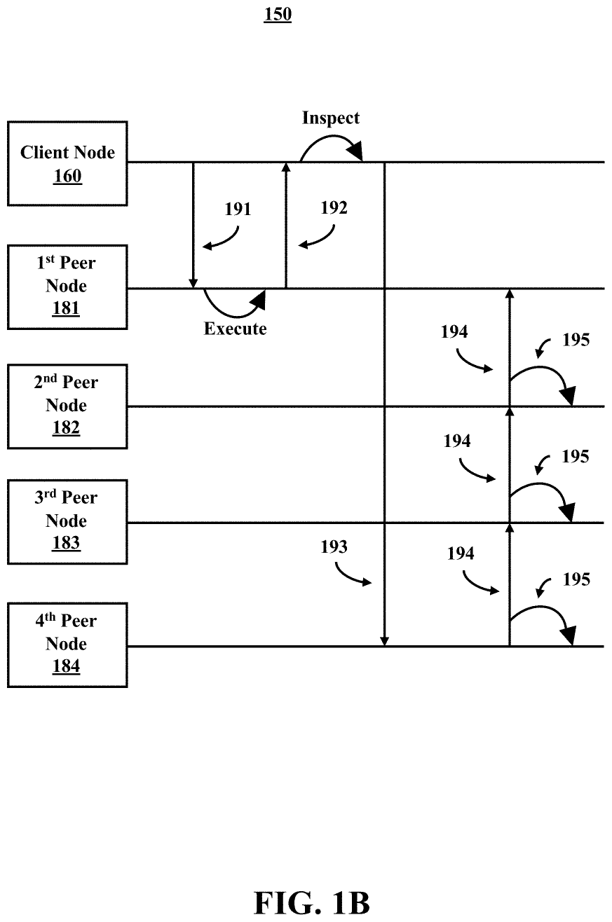

Turning now to FIG. 1A, illustrated is a blockchain architecture 100, in accordance with embodiments of the present disclosure. In some embodiments, the blockchain architecture 100 may include certain blockchain elements, for example, a group of blockchain nodes 102. The blockchain nodes 102 may include one or more blockchain nodes, e.g., peers 104-110 (these four nodes are depicted by example only). These nodes participate in a number of activities, such as a blockchain transaction addition and validation process (consensus). One or more of the peers 104-110 may endorse and/or recommend transactions based on an endorsement policy and may provide an ordering service for all blockchain nodes 102 in the blockchain architecture 100. A blockchain node may initiate a blockchain authentication and seek to write to a blockchain immutable ledger stored in blockchain layer 116, a copy of which may also be stored on the underpinning physical infrastructure 114. The blockchain configuration may include one or more applications 124 which are linked to application programming interfaces (APIs) 122 to access and execute stored program/application code 120 (e.g., chaincode, smart contracts, etc.) which can be created according to a customized configuration sought by participants and can maintain their own state, control their own assets, and receive external information. This can be deployed as a transaction and installed, via appending to the distributed ledger, on all blockchain nodes 104-110.

The blockchain base or platform 112 may include various layers of blockchain data, services (e.g., cryptographic trust services, virtual execution environment, etc.), and underpinning physical computer infrastructure that may be used to receive and store new transactions and provide access to auditors which are seeking to access data entries. The blockchain layer 116 may expose an interface that provides access to the virtual execution environment necessary to process the program code and engage the physical infrastructure 114. Cryptographic trust services 118 may be used to verify transactions such as asset exchange transactions and keep information private.

The blockchain architecture 100 of FIG. 1A may process and execute program/application code 120 via one or more interfaces exposed, and services provided, by blockchain platform 112. The application code 120 may control blockchain assets. For example, the application code 120 can store and transfer data, and may be executed by peers 104-110 in the form of a smart contract and associated chaincode with conditions or other code elements subject to its execution. As a non-limiting example, smart contracts may be generated to execute the transfer of assets/resources, the generation of assets/resources, etc. The smart contracts can themselves be used to identify rules associated with authorization (e.g., asset transfer rules, restrictions, etc.), access requirements (e.g., of a datastore, of an off-chain datastore, of who may participate in a transaction, etc.), and/or usage of the ledger. For example, the verifiable credentials 126 may be processed by one or more processing entities (e.g., virtual machines) included in the blockchain layer 116. The result 128 may include a plurality of linked shared documents (e.g., with each linked shared document recording the issuance of a smart contract in regard to the verifiable credentials 126 being committed by a selected group of peers based on an asset exchange schema, issuer policy, etc.). In some embodiments, the physical infrastructure 114 may be utilized to retrieve any of the data/information/assets/etc. described herein.

A smart contract may be created via a high-level application and programming language, and then written to a block in the blockchain. The smart contract may include executable code that is registered, stored, and/or replicated with a blockchain (e.g., a distributed network of blockchain peers). A transaction is an execution of the smart contract code that can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation of a smart contract, with additional features. As described herein, the chaincode may be program code deployed on a computing network, where it is executed and validated by chain validators together during a consensus process. The chaincode receives a hash and retrieves from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details (e.g., thus committing a transaction associated with assets, etc.).

FIG. 1B illustrates an example of a blockchain transactional flow 150 between nodes of the blockchain in accordance with an example embodiment. Referring to FIG. 1B, the transaction flow may include a transaction proposal 191 sent by an application client node 160 to an endorsing peer node 181 (e.g., in some embodiments, the transaction proposal 191 may include a schema that prescribes a selected set of peers [peer nodes 181-184] to be used for a specific transaction). The endorsing peer 181 may verify the client signature and execute a chaincode function to initiate the transaction. The output may include the chaincode results, a set of key/value versions that were read in the chaincode (read set), and the set of keys/values that were written in chaincode (write set). The proposal response 192 is sent back to the client 160 along with an endorsement signature, if approved. The client 160 assembles the endorsements into a transaction payload 193 and broadcasts it to an ordering service node 184. The ordering service node 184 then delivers ordered transactions as blocks to all peers 181-183 on a channel. Before committal to the blockchain, each peer 181-183 may validate the transaction. For example, the peers may check the endorsement policy to ensure that the correct allotment of the specified peers have signed the results and authenticated the signatures against the transaction payload 193 (e.g., all the specified peers from the schema have validated and approved commitment of the transaction to the blockchain).

Referring again to FIG. 1B, the client node 160 initiates the transaction 191 by constructing and sending a request to the peer node 181, which in this example is an endorser. The client 160 may include an application leveraging a supported software development kit (SDK), which utilizes an available API to generate a transaction proposal 191. The proposal is a request to invoke a chaincode function so that data can be read and/or written to the ledger. The SDK may reduce the package of the transaction proposal 191 into a properly architected format (e.g., protocol buffer over a remote procedure call (RPC)) and take the client's cryptographic credentials to produce a unique signature for the transaction proposal 191.

In response, the endorsing peer node 181 may verify (a) that the transaction proposal 191 is well formed, (b) the transaction has not been submitted already in the past (replay-attack protection), (c) the signature is valid, and (d) that the submitter (client 160, in the example) is properly authorized to perform the proposed operation on that channel. The endorsing peer node 181 may take the transaction proposal 191 inputs as arguments to the invoked chaincode function. The chaincode is then executed against a current state database to produce transaction results including a response value, read set, and write set. However, no updates are made to the ledger at this point. In some embodiments, the set of values, along with the endorsing peer node's 181 signature is passed back as a proposal response 192 to the SDK of the client 160 which parses the payload for the application to consume.

In response, the application of the client 160 inspects/verifies the endorsing peers signatures and compares the proposal responses to determine if the proposal response is the same. If the chaincode only queried the ledger, the application would inspect the query response and would typically not submit the transaction to the ordering node service 184. If the client application intends to submit the transaction to the ordering node service 184 to update the ledger, the application determines if the specified endorsement policy has been fulfilled before submitting. Here, the client may include only one of multiple parties to the transaction. In this case, each client may have their own endorsing node, and each endorsing node will need to endorse the transaction. The architecture is such that even if an application selects not to inspect responses or otherwise forwards an unendorsed transaction, the endorsement policy will still be enforced by peers and upheld at the commit validation phase.

After successful inspection, in the transaction payload step 193, the client 160 assembles endorsements into a transaction and broadcasts the transaction proposal 191 and response within a transaction message to the ordering node 184. The transaction may contain the read/write sets, the endorsing peers signatures and a channel ID (e.g., if a specific [off-chain] datastore is to be utilized). The ordering node 184 does not need to inspect the entire content of a transaction in order to perform its operation, instead the ordering node 184 may simply receive transactions from all channels in the network, order them chronologically by channel, and create blocks of transactions per channel.

The blocks of the transaction are delivered from the ordering node 184 to all peer nodes 181-183 on the channel. The transactions 194 within the block are validated to ensure any endorsement policy is fulfilled and to ensure that there have been no changes to ledger state for read set variables since the read set was generated by the transaction execution. Transactions in the block are tagged as being valid or invalid. Furthermore, in steps 195 each peer node 181-183 appends the block to the channel's chain, and for each valid transaction the write sets are committed to current state database. An event is emitted, to notify the client application that the transaction (invocation) has been immutably appended to the chain, as well as to notify whether the transaction was validated or invalidated.

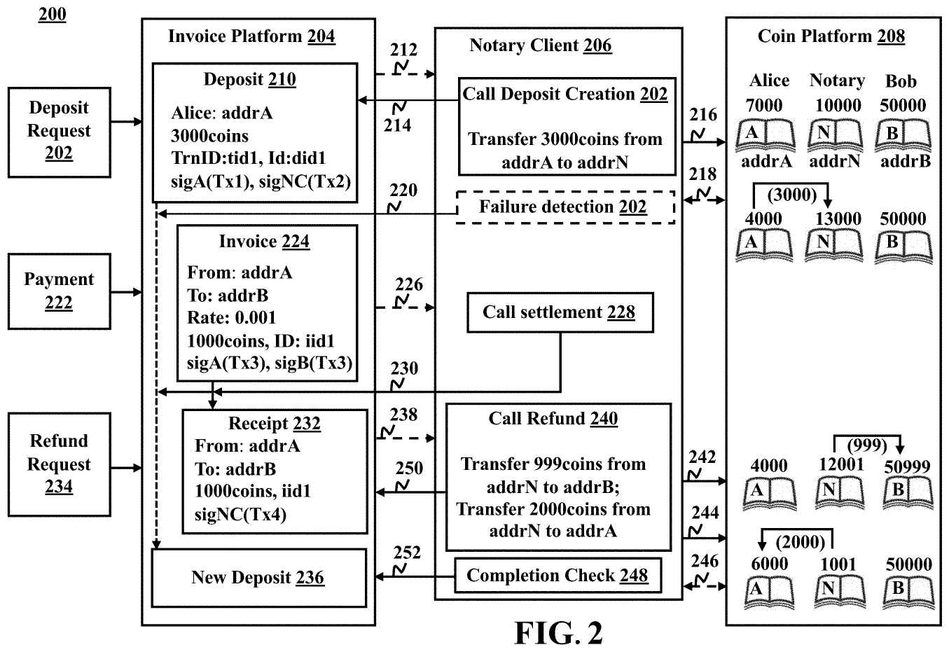

Referring now to FIG. 2, illustrated is an example blockchain network 200 for cross-chain settlements, in accordance with embodiments of the present disclosure. In some embodiments, the blockchain network 200 includes an invoice platform 204 (e.g., a first system), a notary client 206 (e.g., a bridging blockchain client), and a coin platform 208 (e.g., a second system). In some embodiments, the notary client 206 bridges the invoice platform 204 and the coin platform 208 because the invoice platform 204 and the coin platform 208 are either legacy systems and/or other blockchains with different protocols. It is noted that the ledger icons in the coin platform 208 may indicate the differences between blockchains associated with each user of a different platform. It is further noted that without the notary client 206, traditional methods of asset (e.g., information, data) transfer/exchange could not be done between the invoice platform 204 and the coin platform 208.

In some embodiments, the proposed solutions provided herein can be broken into three distinct processes which all work together to form the overall proposed solution, with the first process being a deposit introduction. In such a process, a user (Alice) calls a deposit request 202 for the invoice platform 204 with a signature (e.g., Alice's signature confirming the deposit request 202 is from her, e.g., sigA, Tx1), in some embodiments a number of coins to be accessed for Alice). In some embodiments, in response to the deposit request 202 the invoice platform 204 then rises a coin deposit request event 212 for the notary client 206.

In response to the coin deposit request event 212, the notary client 206 uses a call deposit creation 202 to create/generate a (new locked) deposit 210 asset by a call deposit smart contract 214 (which includes a signature of the notary client 206, e.g., sigNC, Tx2) on the invoice platform 204 with a time-lock, T1 (not shown), (e.g., a deposit smart contract). In some embodiments, the time-lock is released after T times. For example, the smart contract registers time in the invoice platform 204 and a deposit cancel smart contract 220 is valid in T times from the registered time.

In some embodiments, the notary client 206 transfers coins (e.g., 3000 coins) from addrA (Alice's/the payer address) to addrNC (the notary client 206 address) on the invoice platform 204. The notary client 206 then checks 216 whether the coin-transfer is succeeds on the coin platform 208. If the notary client 206 detects coin-transfer-failure 218, the notary client 218 can cancel the deposit creation 202 within T times (e.g., cancel deposit smart contract).

In some embodiments, the second process of the proposed solutions detailed herein may be an invoice-deposit-settlement process, in which, the notary client 206 upon an invoice event or a deposit event 226 utilizes/calls a settlement call 228 for a settlement smart contract (SSC) on the invoice platform 204. In some embodiments, the SSC finds unspent deposits contain enough of an amount of coins owned by Alice (e.g., the invoice-owner) for the target invoice 224 of Alice (which is associated with the payment 222 of Alice to Bob).

In some embodiments, if such deposits can be found, the SSC creates a receipt 232 asset and both the deposit 210 asset for Bob (e.g., the service provider) and a remainder, new deposit 236 asset (e.g., for Alice, the payer). In some embodiments, a settlement-transaction is constructed 230 using the inputs of the invoice 224 and the [input] deposit 210, and output are the new deposit 236 and the receipt 232). In some embodiments, the settlement-transaction is registered in a blockchain (e.g., just as the blockchain associated with the invoice platform 204 and/or coin platform 208, etc.)

In some embodiments, the third process of the proposed solutions detailed herein may be an a deposit elimination process, in which, either of the users, e.g., Alice and/or Bob submit a refund request 234. In such an implementation, the invoice platform 204 receives with a signature from either user or both users the refund request 234, and the invoice platform 234 then raises a refund request event 238 for/to the notary client 206, which then generates a call refund 240.

In some embodiments, upon the call refund 240 generation, the notary client 206 locks a target deposit (e.g., deposit 210, new deposit 236, or any interim deposits if there are more than one transfers involving more than two users, etc.) asset and sets a deposit deletion smart contract on the invoice platform 204 with a T2 time-lock, e.g., a refund smart contract 250. In some embodiments, the time-lock T2 is released and the deletion of the target deposit is cancelled after T times (e.g., the refund smart contract 250 registers a specific time for a refund and a refund permit smart contract 252 is valid in the time-lock T2 form for the specific time).

In some embodiments, the notary client 206 accesses a token 242 and 244 for the notary client 206 associated with both a transfer of coins to both users. In some embodiment, the notary client upon the accesses of the tokens 242 and 244, transfers coins from the address of the notary client 204 in the coin platform 208 to a first address (e.g., digital wallet, etc.) associated with a user address, for instance, addrN (notary client 206 address) to addrA (payer/Alice's refund address) and/or addrN to addrB (payee/Bob's address).

In some embodiments, after an refund is initiated, the notary client 206 checks 246 whether the coin-transfer has succeeded or not. If the notary client 206 detects coin-transfer-success with the completion check 248, the notary client 206 submits permission of the deposit deletion within T times (e.g., submits permission of the refund permit contract 252).

It is noted that in some embodiments, each asset deposit 210, invoice 224, and receipt 232 can be created/generated if required transactions with signatures associated with the users and or notary client 206 are submitted to the invoice platform blockchain. In such and embodiment, the signatures are annotated to each asset (as depicted).

Following the example presented in FIG. 2, a concise example is now discussed. In some embodiments, Alice may have received a ride from Bob and wish to pay him with a cryptocurrency on a specific coin platform, but perhaps Bob does not use the same platform Alice uses. Accordingly, Alice submits a deposit of 3000 coins to pay Bob, a notary client (e.g., abridging blockchain client, notary client 206), using it's account on the specific coin platform. Thus the notary client exchanges 3000 coins from Alice's account (which is found with the address associated with Alice, addrA).

In some embodiments, if the exchange does not happen within a set amount of time (e.g., indicating that perhaps there was an interruption a blockchain) or if Alice is lacking funds, the exchange could fail Alice could be notified of the failure. If the exchange between Alice and the notary client does occur, an invoice is generated indicating how many coins Bob has actually invoiced for the ride, e.g., 1000 coins. In some embodiments, the invoice could be generated and/or submitted by Bob at the same time as the deposit from Alice. Regardless to the invoice generation or submission timing, the notary client can then deposit coins to Bob (e.g., 999 coins because of a 0.1% amount/fee related to using the notary client) and (simultaneously) generate a new deposit indicating the deposit of coins from the notary client to Bob and a receipt that indicates the payment of coins from Alice to Bob. In some embodiments, if Alice had only deposited 1000 coins, which is all that was invoiced, the generation of the receipt may be the last step in the process. However, as depicted, Alice originally deposited 3000 coins, and in such an embodiment, a refund is initiated, where the notary client transfers back 2000 coins back to Alice and another new deposit can be generated indicating the transfer back of coins from the notary client to Alice.

It is noted, that as embodied in FIG. 2 and throughout this specification, that as implemented, the novelty presented is multiplicative. For instance, as of now, almost all exchange mechanisms across chains are targeted for assets with positive values, however this disclosure can use negative valued assets such as the deposit 210 and the invoice 224. That is, deposit 210 is a negative valued asset for the notary client 206 and such a negative-valued asset can be exchanged with a coin in this present embodiment. While dealing with negative assets, it can be guaranteed that participants, other than the notary client 206, will not lose assets, even if the process (e.g., exchange, transfer, etc.) stops halfway.

In such an embodiment with negative assets, a deposit asset creation/deletion process with a coin transfer is specific to a negative asset trade/transfer. That is, there is novelty in that the deposit asset creation has a timed execution lock with cancellation for coin-transfer-failure; and that the deposit asset deletion has a timed rollback lock with execution by permission for successful-coin-transfer. Further, due to such an embodiment, the deposit (e.g., 210, 236) assets and the assumption of the existence of a refund API for the deposit assets can also play the role of coin transfer certificates, even in the situation that the coin-platform cannot issue any transfer certificate.

Further novelty includes unspent transaction output (UTXO) based processing for the invoice 224, receipt 232 and deposit 210 asset. That is, there is an input: as the invoice 224 and some deposits (210, 236, etc.) and there is an output that is the receipt 232 and some deposit (226, etc.). Additionally, as disclosed herein, the proposed solution is concise and streamlined by only assuming a coin-transfer function for the coin platform 208, whereas, almost all other cross-chain asset trading mechanisms assume that a coin platform has other rich functions (e.g., locking a balance, smart contract generation/issuance, and/or issuing receipts for coin-transfers).

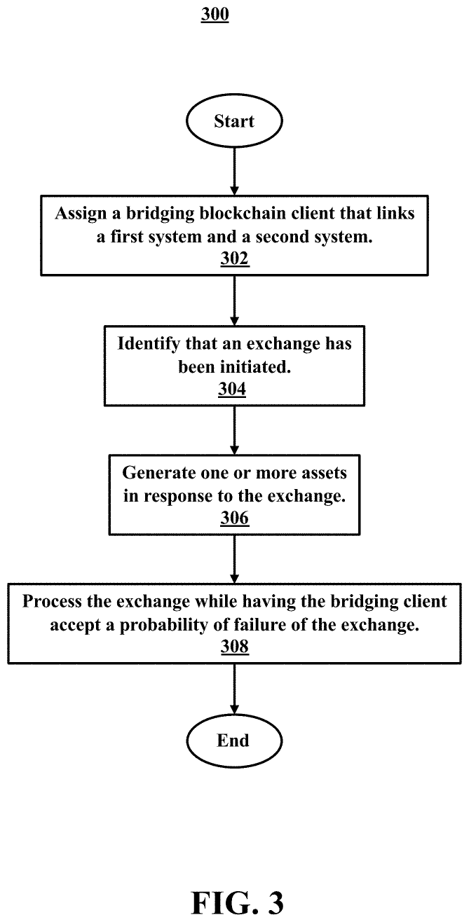

Referring now to FIG. 3, illustrated a flowchart of an example method 300 cross-chain settlements. In some embodiments, the method 300 may be performed by a processor, node, and/or peer node in a blockchain network (such as the blockchain network 200 of FIG. 2). In some embodiments, the method 300 begins at operation 302, where the processor assigns a bridging blockchain client. In some embodiments, the bridging blockchain client may be assigned by a third-party or a user. In some embodiments, the bridging blockchain client links a first system (e.g., an invoice-management-system [ISys]) to a second system (e.g., a coin-management-system [Csys]). In some embodiments, the first and second systems are on one or more (different/separate) blockchains.

In some embodiments, the method 300 proceeds to operation 304, where the processor identifies that an exchange (e.g., transfer, transaction, etc.) has been initiated. In some embodiments, the method 300 proceeds to operation 306, where the processor generates one or more assets in response to the [initiation] of the exchange. In some embodiments, the method 300 proceeds to operation 308, where the processor processes the exchange. In some embodiments, the processing of the exchange includes the bridging blockchain client accepting a probability of failure of the exchange. In some embodiments, after operation 308, the method 300 may end.

For example, a taxi driver may have an invoice system that is out of date when it comes to accepting cryptocurrencies, yet the invoice system may be incorporated into a blockchain network that has a notary (e.g., bridging) client. Thus, when a rider tries to pay the driver with a cryptocurrency, which is incorporated into a cryptocurrency blockchain, the notary client agents the transfer of the cryptocurrency from the rider to the driver by accepting the risk of failure (e.g., the transfer is not validated/committed within a certain time period, etc.) of the currently incompatible invoice system on the blockchain network and the cryptocurrency blockchain.

In some embodiments, at least one of the first and second systems manages the one or more assets. In some embodiments, the one or more assets include deposit, an invoice, and a receipt. Following the example above, the invoice system may generate a deposit asset that represents a deposit asset transaction of the rider paying with the cryptocurrency. In some embodiments, the notary client (using its own account on the cryptocurrency blockchain) identifies whether a transfer from the rider's account is put into the notary client's account. If the transfer is completed, the notary client informs the invoice system, which then generates the invoice asset. The invoice asset indicates the actual amount invoiced by the driver and amount that is to be transferred from the rider's account to an account associated with the driver. In some embodiments, the transfer is completed (after a refund, which was previously discussed above in regard to FIG. 2) and a receipt asset is generated which provides evidence of the transfer of assets (e.g., the rid for the cryptocurrency) to the blockchain(s).

In some embodiments, discussed below, there are one or more operations of the method 300 not depicted for the sake of brevity. Accordingly, in some embodiments, generating the one or more assets in response to the exchange may include the processor generating the deposit asset. The deposit asset may include a first address, an amount to be deposited, an account on one of the first or second systems, and a deposit ID (which may provide evidence of the asset to a blockchain network). The processor may couple a timed execution lock to the deposit asset. The timed execution lock may be associated with a threshold time limit for the exchanged amount from the first address to the account. For example, a user may try to deposit 100 coins to their account on a particular cryptocurrency blockchain and the user has one minute to change the amount of coins to deposit and/or can cancel the deposit.

In some embodiments, the processor may (further) generate the invoice asset, where the invoice asset may include the first address (e.g., a payee/payor account number, digital wallet, etc.), a second address, an amount to be exchanged (e.g., coins from the payor), a rate for the exchange (e.g., a processing rate), the account number on one of the first or second systems (e.g., the bridging blockchain client's address on a coin platform), and an invoice ID.

In some embodiments, the processor may (further) generate the receipt asset, where the receipt asset may include the first address, the second address, the amount to be exchanged, the invoice ID, the deposit ID, and a receipt ID (in which all may be committed to a blockchain to verify the transaction occurred). In some embodiments, the processor may simultaneously generate a new deposit asset that includes information of the exchanged amount to the second address. For example, if the payor over-deposits a refund can be issued denoting the deposit back to the payor.

In some embodiments, processing the exchange may include the processor determining whether the exchange was successful (e.g., at either of the times discussed above in regard to FIG. 2). In some embodiments, determining whether the exchange was successful includes identifying that there was a transfer of a digital asset (e.g., cryptocurrency, coin, etc.). For example, it may be determined that the deposit of coins to the account associated with the bridging blockchain client occurred and/or that a deposit asset deletion (e.g., refund) occurred.

In some embodiments, determining the exchange whether the exchange was successful includes detecting a failure of a transfer of a digital asset and/or cancelling the generation of at least one of the one or more assets (e.g., deposit asset creation).

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

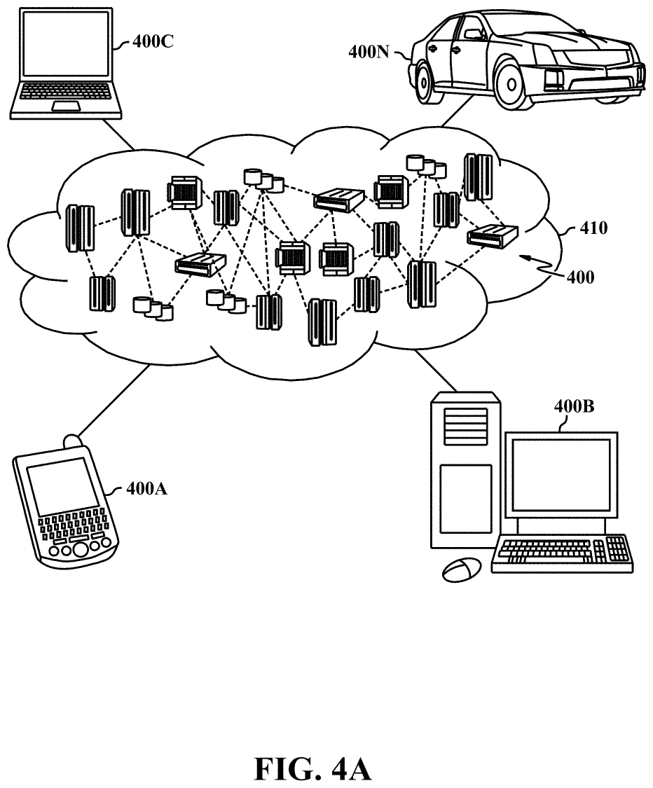

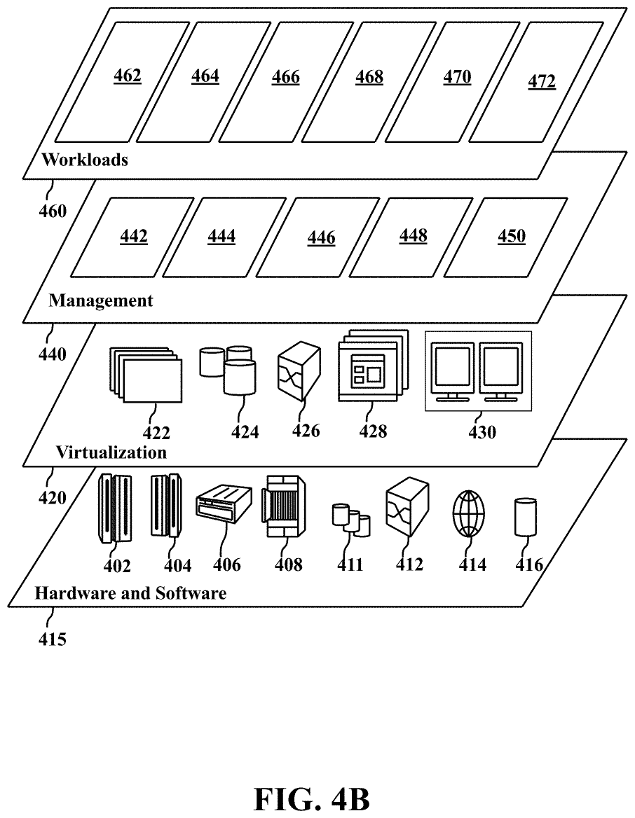

FIG. 4A, illustrated is a cloud computing environment 410 is depicted. As shown, cloud computing environment 410 includes one or more cloud computing nodes 400 with which local computing devices used by cloud consumers, such as, for example, personal digital assistant (PDA) or cellular telephone 400A, desktop computer 400B, laptop computer 400C, and/or automobile computer system 400N may communicate. Nodes 400 may communicate with one another. They may be grouped (not shown) physically or virtually, in one or more networks, such as Private, Community, Public, or Hybrid clouds as described hereinabove, or a combination thereof.

This allows cloud computing environment 410 to offer infrastructure, platforms and/or software as services for which a cloud consumer does not need to maintain resources on a local computing device. It is understood that the types of computing devices 400A-N shown in FIG. 4A are intended to be illustrative only and that computing nodes 400 and cloud computing environment 410 can communicate with any type of computerized device over any type of network and/or network addressable connection (e.g., using a web browser).

FIG. 4B, illustrated is a set of functional abstraction layers provided by cloud computing environment 410 (FIG. 4A) is shown. It should be understood in advance that the components, layers, and functions shown in FIG. 4B are intended to be illustrative only and embodiments of the disclosure are not limited thereto. As depicted below, the following layers and corresponding functions are provided.

Hardware and software layer 415 includes hardware and software components. Examples of hardware components include: mainframes 402; RISC (Reduced Instruction Set Computer) architecture based servers 404; servers 406; blade servers 408; storage devices 411; and networks and networking components 412. In some embodiments, software components include network application server software 414 and database software 416.

Virtualization layer 420 provides an abstraction layer from which the following examples of virtual entities may be provided: virtual servers 422; virtual storage 424; virtual networks 426, including virtual private networks; virtual applications and operating systems 428; and virtual clients 430.

In one example, management layer 440 may provide the functions described below. Resource provisioning 442 provides dynamic procurement of computing resources and other resources that are utilized to perform tasks within the cloud computing environment. Metering and Pricing 444 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 446 provides access to the cloud computing environment for consumers and system administrators. Service level management 448 provides cloud computing resource allocation and management such that required service levels are met. Service Level Agreement (SLA) planning and fulfillment 450 provide pre-arrangement for, and procurement of, cloud computing resources for which a future requirement is anticipated in accordance with an SLA.

Workloads layer 460 provides examples of functionality for which the cloud computing environment may be utilized. Examples of workloads and functions which may be provided from this layer include: mapping and navigation 462; software development and lifecycle management 464; virtual classroom education delivery 466; data analytics processing 468; transaction processing 470; and cross-chain settlements 472.

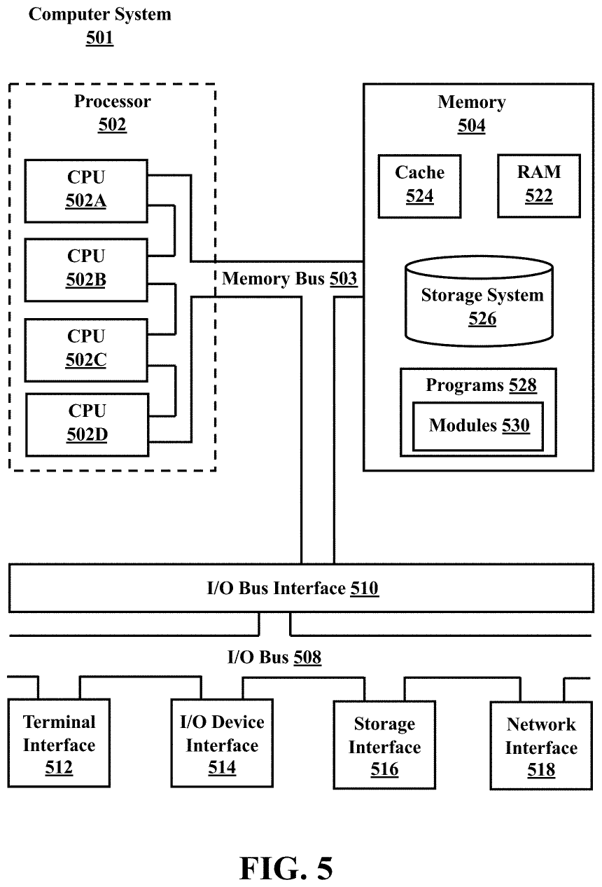

FIG. 5, illustrated is a high-level block diagram of an example computer system 501 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 501 may comprise one or more CPUs 502, a memory subsystem 504, a terminal interface 512, a storage interface 516, an I/O (Input/Output) device interface 514, and a network interface 518, all of which may be communicatively coupled, directly or indirectly, for inter-component communication via a memory bus 503, an I/O bus 508, and an I/O bus interface unit 510.

The computer system 501 may contain one or more general-purpose programmable central processing units (CPUs) 502A, 502B, 502C, and 502D, herein generically referred to as the CPU 502. In some embodiments, the computer system 501 may contain multiple processors typical of a relatively large system; however, in other embodiments the computer system 501 may alternatively be a single CPU system. Each CPU 502 may execute instructions stored in the memory subsystem 504 and may include one or more levels of on-board cache.

System memory 504 may include computer system readable media in the form of volatile memory, such as random access memory (RAM) 522 or cache memory 524. Computer system 501 may further include other removable/non-removable, volatile/non-volatile computer system storage media. By way of example only, storage system 526 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 504 can include flash memory, e.g., a flash memory stick drive or a flash drive. Memory devices can be connected to memory bus 503 by one or more data media interfaces. The memory 504 may include at least one program product having a set (e.g., at least one) of program modules that are configured to carry out the functions of various embodiments.

One or more programs/utilities 528, each having at least one set of program modules 530 may be stored in memory 504. The programs/utilities 528 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 528 and/or program modules 530 generally perform the functions or methodologies of various embodiments.

Although the memory bus 503 is shown in FIG. 5 as a single bus structure providing a direct communication path among the CPUs 502, the memory subsystem 504, and the I/O bus interface 510, the memory bus 503 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 510 and the I/O bus 508 are shown as single respective units, the computer system 501 may, in some embodiments, contain multiple I/O bus interface units 510, multiple I/O buses 508, or both. Further, while multiple I/O interface units are shown, which separate the I/O bus 508 from various communications paths running to the various I/O devices, in other embodiments some or all of the I/O devices may be connected directly to one or more system I/O buses.

In some embodiments, the computer system 501 may be a multi-user mainframe computer system, a single-user system, or a server computer or similar device that has little or no direct user interface, but receives requests from other computer systems (clients). Further, in some embodiments, the computer system 501 may be implemented as a desktop computer, portable computer, laptop or notebook computer, tablet computer, pocket computer, telephone, smartphone, network switches or routers, or any other appropriate type of electronic device.

It is noted that FIG. 5 is intended to depict the representative major components of an exemplary computer system 501. In some embodiments, however, individual components may have greater or lesser complexity than as represented in FIG. 5, components other than or in addition to those shown in FIG. 5 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A method for cross-chain settlements, the method comprising:
assigning, by a processor, a bridging blockchain client, wherein the bridging blockchain client links a first system to a second system, and wherein the first and second systems are on one or more blockchains;
identifying that an exchange has been initiated;
generating one or more assets in response to the exchange; and
processing the exchange, wherein processing the exchange includes the bridging blockchain client accepting a probability of failure of the exchange.

2. The method of claim 1, wherein at least one of the first and second systems manages the one or more assets, wherein the one or more assets include a deposit asset, an invoice asset, and a receipt asset.

3. The method of claim 2, wherein generating the one or more assets in response to the exchange comprises:
generating the deposit asset, wherein the deposit asset includes a first address, an amount to be deposited, an account on one of the first or second systems, and a deposit ID; and
coupling a timed execution lock to the deposit asset, wherein the timed execution lock is associated with a threshold time limit for the exchanged amount from the first address to the account.

4. The method of claim 3, further comprising:
generating the invoice asset, wherein the invoice asset includes the first address, a second address, an amount to be exchanged, a rate for the exchange, the account number on one of the first or second systems, and an invoice ID.

5. The method of claim 4, further comprising:
generating the receipt asset, wherein the receipt asset includes the first address, the second address, the amount to be exchanged, the invoice ID, the deposit ID, and a receipt ID; and
generating, simultaneously, a new deposit asset that includes information of the exchanged amount to the second address.

6. The method of claim 1, wherein processing the exchange comprises:
determining whether the exchange was successful.

7. The method of claim 6, wherein determining whether the exchange was successful comprises:
identifying that that there was a transfer of a digital asset.

8. The method of claim 6, wherein determining whether the exchange was successful comprises:
detecting a failure of a transfer of a digital asset; and
cancelling the generation of at least one of the one or more assets.

9. A system for cross-chain settlements, the system comprising:
a memory; and
a processor in communication with the memory, the processor being configured to perform operations comprising:
assigning a bridging blockchain client, wherein the bridging blockchain client links a first platform to a second platform, and wherein the first and second platforms are on one or more blockchains;
identifying that an exchange has been initiated;
generating one or more assets in response to the exchange; and
processing the exchange, wherein processing the exchange includes the bridging blockchain client accepting a probability of failure of the exchange.

10. The system of claim 9, wherein at least one of the first and second platforms manages the one or more assets, wherein the one or more assets include a deposit asset, an invoice asset, and a receipt asset.

11. The system of claim 10, wherein generating the one or more assets in response to the exchange comprises:
generating the deposit asset, wherein the deposit asset includes a first address, an amount to be deposited, an account on one of the first or second platforms, and a deposit ID; and
coupling a timed execution lock to the deposit asset, wherein the timed execution lock is associated with a threshold time limit for the exchanged amount from the first address to the account.

12. The system of claim 11, wherein the operations further comprise:
generating the invoice asset, wherein the invoice asset includes the first address, a second address, an amount to be exchanged, a rate for the exchange, the account number on one of the first or second platforms, and an invoice ID.

13. The system of claim 12, wherein the operations further comprise:
generating the receipt asset, wherein the receipt asset includes the first address, the second address, the amount to be exchanged, the invoice ID, the deposit ID, and a receipt ID; and
generating, simultaneously, a new deposit asset that includes information of the exchanged amount to the second address.

14. The system of claim 9, wherein processing the exchange comprises:
determining whether the exchange was successful.

15. The system of claim 14, wherein determining whether the exchange was successful comprises:
identifying that that there was a transfer of a digital asset.

16. The system of claim 14, wherein determining whether the exchange was successful comprises:
detecting a failure of a transfer of a digital asset; and
cancelling the generation of at least one of the one or more assets.

17. A computer program product for cross-chain settlements, the computer program product comprising a computer readable storage medium having program instructions embodied therewith, the program instructions executable by a processor to cause the processors to perform a function, the function comprising:
assigning a bridging blockchain client, wherein the bridging blockchain client links a first platform to a second platform, and wherein the first and second platforms are on one or more blockchains;
identifying that an exchange has been initiated;
generating one or more assets in response to the exchange; and
processing the exchange, wherein processing the exchange includes the bridging blockchain client accepting a probability of failure of the exchange.

18. The computer program product of claim 17, wherein at least one of the first and second platforms manages the one or more assets, wherein the one or more assets include a deposit asset, an invoice asset, and a receipt asset.

19. The computer program product of claim 18, wherein generating the one or more assets in response to the exchange comprises:
generating the deposit asset, wherein the deposit asset includes a first address, an amount to be deposited, an account on one of the first or second platforms, and a deposit ID; and
coupling a timed execution lock to the deposit asset, wherein the timed execution lock is associated with a threshold time limit for the exchanged amount from the first address to the account.

20. The computer program product of claim 19, wherein the functions further comprise:
generating the invoice asset, wherein the invoice asset includes the first address, a second address, an amount to be exchanged, a rate for the exchange, the account number on one of the first or second platforms, and an invoice ID.
